(19) United States
(12) Patent Application Publication
(10) Pub. No.: US 2015/0110455 A1
(43) Pub. Date: Apr. 23, 2015

(54) UTILITY AND METHOD FOR CAPTURING COMPUTER-GENERATED VIDEO OUTPUT

(71) Applicant: Nvidia Corporation, Santa Clara, CA (US)

(72) Inventors: Lu Liu, Santa Clara, CA (US); Rochelle Pereira, Santa Clara, CA (US); Somnath Kopnar, Pune (IN)

(73) Assignee: Nvidia Corporation, Santa Clara, CA (US)

(21) Appl. No.: 14/171,085

(22) Filed: Feb. 3, 2014

Related U.S. Application Data
(60) Provisional application No. 61/894,784, filed on Oct. 23, 2013.

(51) Int. Cl. H04N 5/775; G11B 27/19

(52) U.S. Cl. CPC H04N 5/775; G11B 27/19
USPC 386/201; 386/200

(57) ABSTRACT

A video capture utility and method for a computer system. In one embodiment, the video capture utility includes: (1) a circular buffer allocated in a memory of the computer system to store at most a predefined video length, (2) a video output interceptor executable in a processor of the computer system and operable to receive and store video output most recently generated by an application program and (3) a video output extractor executable in the processor and operable to prompt contents of the circular buffer to be copied from the circular buffer to another location.

### CROSS-REFERENCE TO RELATED APPLICATION

This application claims the benefit of U.S. Provisional Application Ser. No. 61/894,784, filed by Liu, et al., on Oct. 23, 2013, entitled “Method for Capturing Past Few Minutes of Gameplay,” commonly assigned with this application and incorporated herein by reference.

### TECHNICAL FIELD

This application is directed, in general, to computer-generated video output and, more specifically, to a system and method for capturing computer-generated video output.

### BACKGROUND

Arguably the primary output medium for computers is their video display. While the very earliest computers provided their output in the form of blinking lights, printouts and magnetic tape spools, it is essentially impossible to imagine operating a modern computer, which almost universally employs a graphical user interface (GUI), without the benefit of viewing its video display.

Occasionally users wish to capture the video output produced by their computers. Perhaps they have an intermittent problem with their computer and would like a technician to review the captured video output for clues they might not otherwise have a chance to see. Perhaps they are having trouble mastering a software application and would like to get help from a more experienced user who would benefit from seeing the video output. Perhaps they are having trouble playing a game and want a more adept player watch what they are doing wrong. On the other hand, perhaps they have played a game in a spectacular way and would like to share their achievement with their friends.

Fortunately, software tools exist for capturing video output. For example, Fraps is a game capture video recorder commercially available from Beepa Pty Ltd. Fraps allows a user to start and stop the recording of video output. The user can then save the video recorded between the starting and the stopping to a file and share it with others. These software tools appear to do a reasonable job of meeting the above-described needs.

### SUMMARY

One aspect provides a video capture utility for a computer system. In one embodiment, the video capture utility includes: (1) a circular buffer allocated in a memory of the computer system to store at most a predefined video length, (2) a video output interceptor executable in a processor of the computer system and operable to receive and store video output most recently generated by an application program and (3) a video output extractor executable in the processor and operable to prompt contents of the circular buffer to be copied from the circular buffer to another location.

In another embodiment, the video capture utility includes: (1) a circular buffer allocated in a memory of the computer system to store at most a predefined video length, (2) a video output interceptor executable in a processor of the computer system and operable to receive and store video output most recently generated by an application program and (3) a video output extractor executable in the processor and operable to respond to a user command by prompting the contents of the circular buffer to be copied from the circular buffer to a video file.

Another aspect provides a video capture method for a computer system. In one embodiment, the video capture method includes: (1) intercepting video output most recently generated by an application program, (2) storing the video output in a circular buffer allocated in a memory of the computer system and configured to store at most a predefined video length and (3) prompting contents of the circular buffer to be copied from the circular buffer to another location.

### BRIEF DESCRIPTION

Reference is now made to the following descriptions taken in conjunction with the accompanying drawings, in which:

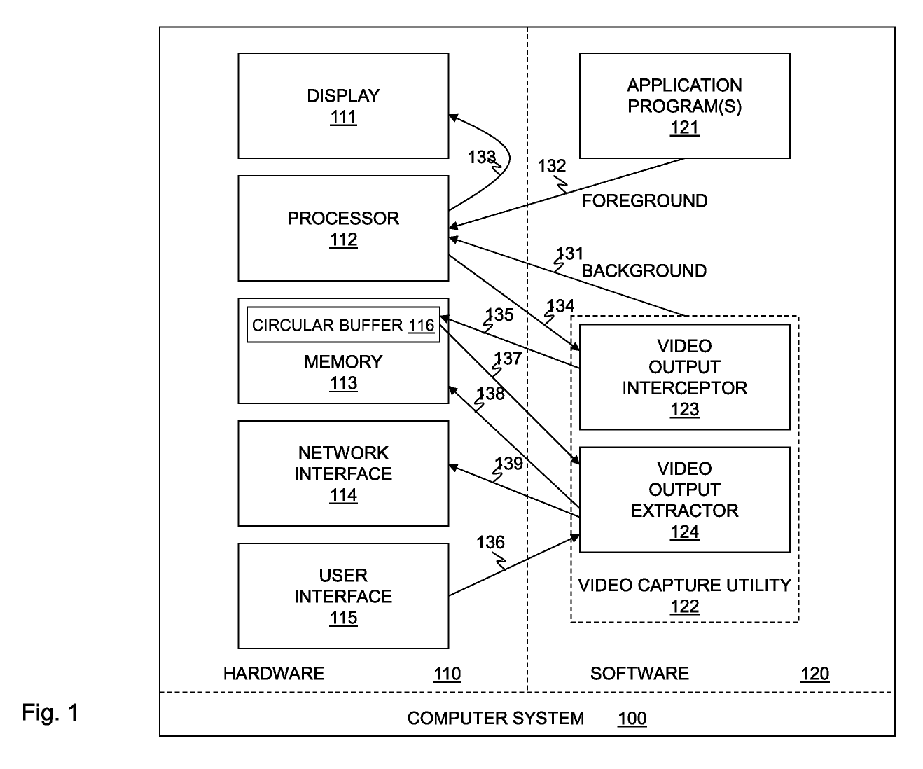

FIG. 1 is a block diagram of one embodiment of a utility for capturing computer-generated video output; and

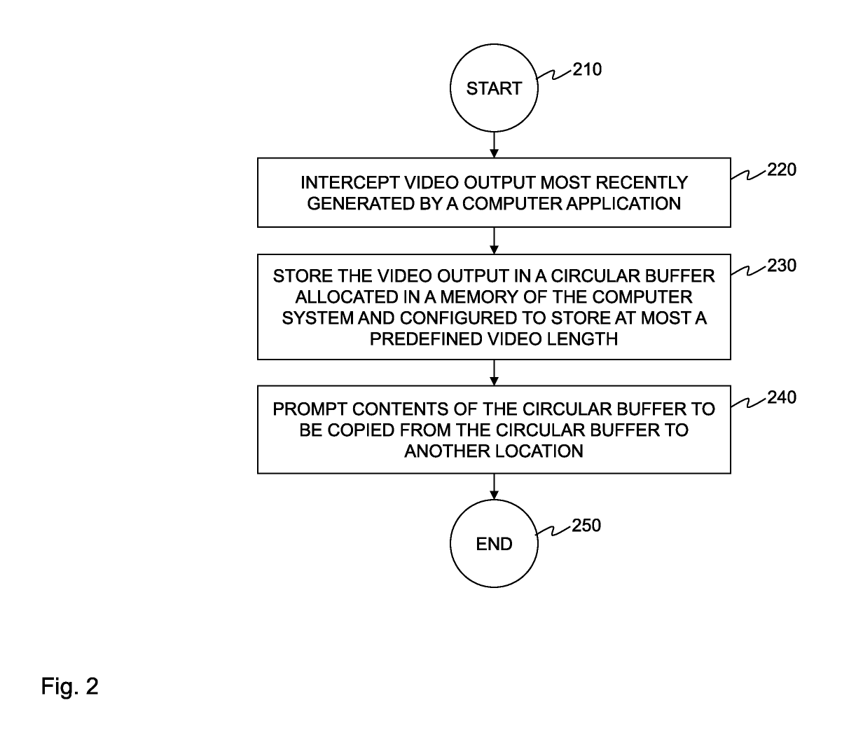

FIG. 2 is a flow diagram of one embodiment of a method of capturing computer-generated video output.

### DETAILED DESCRIPTION

It is realized herein that, while conventional tools for capturing vide output are of value when the user is aware that he is about to need to create a recording (i.e. is able to initiate a recording before the video output that he wants to record has been generated), they have little if any value after the fact, namely after something has occurred in the video output that the user wishes he could have captured. In the examples given in the Background above, a user would benefit from a utility that would record constantly and able to create, when the user so desires, a record of video output that had been generated in the past. It is realized herein that a utility that records video output in the background and can, upon demand, produce video output that had been generated perhaps over the last several minutes, would be advantageous.

Accordingly, introduced herein are various embodiments of a utility and method for capturing computer-generated video output. The various embodiments are operable in the context of a computer system, which may be a desktop computer, laptop computer, tablet computer, smartphone or gaming system.

FIG. 1 is a block diagram of one embodiment of a utility for capturing computer-generated video output. The utility is illustrated in the context of a computer system 100. The computer system 100 has hardware 110 that provides an environment for executing software 120, including a software embodiment of the utility. In the illustrated embodiment, the hardware 110 includes a display 111, a processor 112, a memory 113, a network interface 114 and a user interface 115. The display 111 may be of any conventional or later-developed type. The processor 112 may be one or more of a central processing unit (CPU) and a graphics processing unit (GPU). In one embodiment, the processor 112 is a plurality of GPUs coupled together by a Scalable Link Interface (SLI)™, which is a brand name for a multi-GPU technology developed by Nvidia Corporation of Santa Clara, California, for linking two or more video cards together to produce a single output. The memory 113 is typically stratified into caches, main memory and nonvolatile storage, such as one or more hard disk drives, although any memory configuration is contemplated. The network interface 114 may be wireline or wireless and is generally operable for coupling the computer system to a network such as the Internet. The user interface 115 may include a keyboard, a mouse, a microphone, a speaker or other input or output devices, which are in addition to the display 111.

One or more application programs 121 execute on the processor 112. At least one of the application programs 121, typically executing in the foreground, generates video output that is provided to the display 111. As stated above, it is desirable to capture this video output, and perhaps the entirety of what is displayed on the entire display 111, for posterity's sake.

Accordingly, a video capture utility 122 executes in the processor, perhaps in the background. One embodiment of the video capture utility causes a circular buffer 116 to be allocated and established in the memory 113. The circular buffer 116 is of a predefined size, such that it is capable of storing, at most, a predefined video length. In the illustrated embodiment, the predefined video length is user-configurable. In the illustrated embodiment, the predefined video length is less than five minutes, however, only the size of the memory 113 limits the size of the circular buffer 116. Those skilled in the pertinent art will understand, however, that the scope of the invention includes video lengths of minutes, hours or even many days, subject to the size of memory allocated to the circular buffer 116.

A video output interceptor 123 of the video capture utility 122 is executable in the processor 112 and is operable to receive and store video output most recently generated by an application program. A video output extractor 124 of the video capture utility 122 is executable in the processor 112 and is operable to prompt contents of the circular buffer 116 to be copied from the circular buffer 116 to another location, which will be described in greater detail. In the illustrated embodiment, the video output extractor 124 is further operable to respond to a user command by prompting the contents of the circular buffer 116 to be copied.

The illustrated embodiment of the video capture utility 122 is probably best understood with reference to it operation in context. Accordingly, FIG. 1 shows various arrows. The arrows indicate interactions among the hardware 110 and the software 120. One example of the operation of the video capture utility 122 will now be given.

The video capture utility 122 begins to execute in the processor 112, indicated by an arrow 131. In the illustrated embodiment, the video capture utility 122 executes in the background. An application program 121 also begins to execute in the processor 112, indicated by an arrow 132. In the illustrated embodiment, the application program 121 executes in the foreground.

The application program 122 causes video output to be transmitted to the display 111, indicated by an arrow 133. The video output interceptor 123 intercepts the video output, as indicated by an arrow 134, and causes it to be stored in the circular buffer 116, as indicated by an arrow 135. The circular buffer 116 begins to fill with video output. When the circular buffer 116 completely fills, the most recent video output begins to overwrite the least recent video output. This process continues over time, such that the circular buffer 116 contains the video output most recently generated by the application program 121. This is the nature of a circular buffer, which is itself a conventional data structure known to those skilled in the pertinent art.

At some later time, it is assumed that the video output contained in the circular buffer 116 is to be extracted and copied to another location. It is assumed for purposes of the illustrated embodiment, that a user desires to save the video output in some manner. Accordingly, the user generates a user command of some sort (e.g., a hot key on a keyboard thereof). The video output extractor 124 receives the user command, as indicated by an arrow 136. The video output extractor 124 responds by prompting the contents of the circular buffer 116 to be copied from the circular buffer 116, as indicated by an arrow 137. In one embodiment, the video output extractor 124 causes the contents to be placed in a video file, which would often be stored in the memory 113 outside of the circular buffer 116, as indicated by an arrow 138. In another embodiment, the video output extractor 124 causes the contents to be transformed into a video stream, which may then be transmitted over a network (not shown) coupled to network interface 114, as indicated by an arrow 139. In one embodiment, the video output may be deleted from the circular buffer 116 following extraction.

In the illustrated embodiment, the video output interceptor 123 thereafter resumes placing output video in the circular buffer 116, which then becomes available for later extraction, if desired.

In the illustrated embodiment, the video output interceptor 123 is further operable to receive and store audio output most recently generated by the application program 121 and synchronize the video output and the audio output. The video and audio output may be interleaved in the circular buffer 116. One technique for maintaining reasonable synchronization involves checking time stamps of samples of video and audio output to determine whether they are sufficiently temporally proximate (e.g., within 500 milliseconds of each other) of the audio sample's time stamp. Samples of video or audio content may be disregarded to maintain reasonable synchronization.

FIG. 2 is a flow diagram of one embodiment of a method of capturing computer-generated video output. The method begins in a start step 210. In a step 220, video output most recently generated by an application program is intercepted. The video output is still allowed to be transmitted to the display. In a step 230, the video output is stored in a circular buffer allocated in a memory of the computer system and configured to store at most a predefined video length. In a step 240, contents of the circular buffer are prompted to be copied from the circular buffer to another location, perhaps in response to a user command. In one embodiment, the other location is a video file. In another embodiment, the other location is a video stream over a network coupled to the computer system. The method ends in an end step 250.

Those skilled in the art to which this application relates will appreciate that other and further additions, deletions, substitutions and modifications may be made to the described embodiments.

What is claimed is:

1. A video capture utility for a computer system, comprising:
a circular buffer allocated in a memory of said computer system to store at most a predefined video length;
a video output interceptor executable in a processor of said computer system and operable to receive and store video output most recently generated by an application program; and
a video output extractor executable in said processor and operable to prompt contents of said circular buffer to be copied from said circular buffer to another location.

2. The video capture utility as recited in claim 1 wherein said video output extractor is further operable to respond to a user command by prompting said contents of said circular buffer to be copied.

3. The video capture utility as recited in claim 1 wherein said other location is a selected one of:
a video file, and
a video stream over a network coupled to said computer system.

4. The video capture utility as recited in claim 1 wherein said video output interceptor executes in a background of said processor and said computer application executes in a foreground of said processor.

5. The video capture utility as recited in claim 1 wherein said circular buffer is further operable to store video output most recently generated for an entire display of said computer system.

6. The video capture utility as recited in claim 1 wherein said video output interceptor is further operable to receive and store audio output most recently generated by said application program and synchronize said video output and said audio output.

7. The video capture utility as recited in claim 1 wherein said predefined video length is less than an hour.

8. A video capture method for a computer system, comprising:
intercepting video output most recently generated by an application program;
storing said video output in a circular buffer allocated in a memory of said computer system and configured to store at most a predefined video length; and
prompting contents of said circular buffer to be copied from said circular buffer to another location.

9. The video capture method as recited in claim 8 wherein said prompting comprises prompting in response to a user command.

10. The video capture method as recited in claim 8 wherein said other location is a selected one of:
a video file, and
a video stream over a network coupled to said computer system.

11. The video capture method as recited in claim 8 wherein said intercepting and said storing are carried out in a background of said processor and said application program executes in a foreground of said processor.

12. The video capture method as recited in claim 8 wherein said storing comprises storing video output most recently generated for an entire display of said computer system.

13. The video capture method as recited in claim 8 wherein said intercepting comprises:
intercepting audio output most recently generated by said application program;
synchronizing said video output and said audio output; and
storing said audio output in said circular buffer.

14. The video capture method as recited in claim 8 wherein said predefined video length is less than an hour.

15. A video capture utility for a computer system, comprising:
a circular buffer allocated in a memory of said computer system to store at most a predefined video length;
a video output interceptor executable in a processor of said computer system and operable to receive and store video output most recently generated by an application program; and
a video output extractor executable in said processor and operable to respond to a user command by prompting said contents of said circular buffer to be copied from said circular buffer to a video file.

16. The video capture utility as recited in claim 15 wherein said video output extractor is further operable to prompt said contents to be copied to a video stream over a network coupled to said computer system.

17. The video capture utility as recited in claim 15 wherein said video output interceptor executes in a background of said processor and said computer application executes in a foreground of said processor.

18. The video capture utility as recited in claim 15 wherein said circular buffer is further operable to store video output most recently generated for an entire display of said computer system.

19. The video capture utility as recited in claim 15 wherein said video output interceptor is further operable to receive and store audio output most recently generated by said application program and synchronize said video output and said audio output.

20. The video capture utility as recited in claim 15 wherein said predefined video length is less than ten minutes.
